(19) United States
(12) Patent Application Publication
(10) Pub. No.: US 2005/0246904 A1
(43) Pub. Date: Nov. 10, 2005

(54) Cutting member having a superlattice coating

(75) Inventors: Dirk Herbert Johan Teeuw, Drachten (NL); Ype Bernardus Brada, Drachten (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/525,137

(22) PCT Filed: Jul. 14, 2003
(86) PCT No.: PCT/IB03/03217

§ 371 Date: Feb. 16, 2005

(30) Foreign Application Priority Data
Aug. 21, 2002 (EP) 02078459.1

(51) Int. Cl. B26B 21/54

(52) U.S. Cl. 30/346.54

(57) ABSTRACT

The invention relates to a cutting member (7) for use in a device for shaving hair. The cutting member comprises a meal substrate (15) which is provided with a cutting edge (9). At least a portion of the substrate including the cutting edge is provided with a protective coating (19). According to the invention the coating (19) comprises a plurality of stacked pairs (21) of layers, wherein each pair of layers comprises a first layer (23) mainly comprising carbon (C) and a second layer (25) mainly comprising a metal, and wherein each pair of layers has a thickness (TP) between 1 and 10 nm. The second layer preferably comprises Cr, Nb, Mo, Ti, V, or W. As a result, the coating has a superlattice structure which provides the coating with physical properties which are superior to the properties of the individual materials of the layers. In an embodiment wherein the second layer comprises Cr and each pair (21) of layers has a thickness of 1.8 nm, the coating (19) has a hardness that is approximately four times the hardness of Cr and provides a coefficient of friction between the cutting member (7) and the hair to be shaved which is considerably lower than the coefficient of friction which would be obtained without the coating.

The invention relates to a cutting member for use in a device for shaving hair, said cutting member having a metal substrate which is provided with a cutting edge, at least a portion of the substrate including the cutting edge being provided with a coating comprising carbon.

The invention further relates to a device for shaving hair comprising a cutting member having a metal substrate which is provided with a cutting edge, at least a portion of the substrate including the cutting edge being provided with a coating comprising carbon.

A cutting member and a device for shaving hair of the kinds mentioned in the opening paragraphs are known from EP-B-0 591 339. The known cutting member is a razor blade comprising a blade-shaped substrate made of steel provided with a straight wedge-shaped cutting edge. The known device for shaving hair is a razor comprising two such known razor blades which are arranged in a disposable shaving head. A portion of the substrate, which includes the cutting edge, is provided with a coating of diamond-like carbon (DLC), an intermediate layer of molybdenum being provided between the substrate and the DLC coating to improve the adhesion of the coating to the substrate. The DLC coating has a relatively high hardness and resistance to wear, so that the resistance to wear of the cutting member and particularly of the wedge-shaped cutting edge is considerably improved and the term of life of the cutting member is considerably prolonged. In addition the DLC coating provides a relatively low coefficient of friction between the cutting member and the hair to be shaved, as a result of which the shaving comfort of the cutting member is considerably improved.

It is an object of the invention to provide a cutting member and a device for shaving hair of the kinds mentioned in the opening paragraphs which provide shaving comfort which is at least comparable to the shaving comfort of the known cutting member and of the known device for shaving hair, but wherein the resistance to wear and the durability of the cutting member are improved.

In order to achieve this object, a cutting member in accordance with the invention is characterized in that the coating comprises a plurality of stacked pairs of layers, each pair comprising a first layer mainly comprising carbon and a second layer mainly comprising a metal, and each pair having a thickness between 1 and 10 nm.

In order to achieve this object, a device for shaving hair in accordance with the invention is characterized in that the cutting member used therein is a cutting member in accordance with the invention.

As a result of the fact that the coating comprises a plurality of stacked pairs of layers, wherein the thickness of each pair of layers is between 1 and 10 nm, a nano-scale multi-layered coating is achieved wherein the atoms present in adjacent layers of the coating will be arranged in a so-called superlattice. A number of physical properties of such a superlattice coating are superior to the physical properties which the materials of the layers of the coating have individually and which the coating would have if the thickness of the layers was much larger. It was found that, if in accordance with the invention each pair of layers of the superlattice coating of the cutting member comprises a first layer mainly comprising carbon and a second layer mainly comprising a metal, the coating provides a coefficient of friction between the cutting member and the hair to be shaved which, as a result of the presence of carbon in the coating, is considerably lower than the coefficient of friction obtained without the coating, while the coating has a hardness, as a result of the presence of said metal in the coating, which is a multiple of the hardness of the individual metal and, as a result, is considerably higher than the average hardness of a DLC coating if a suitable metal is used. As a result, the cutting member and the device for shaving hair in accordance with the invention have a shaving comfort which is at least comparable to the shaving comfort of the known cutting member and the known device for shaving hair, but they have a resistance to wear and a life time which are considerably improved.

A particular embodiment of a cutting member according to the invention is characterized in that the second layer comprises Cr, Nb, Mo, Ti, V, or W. Said metals individually have a relatively high hardness, so that in this embodiment, wherein the second layer of each pair of layers of the coating comprises one of said metals, the hardness of the coating is superior to the average hardness of a DLC coating.

A particular embodiment of a cutting member according to the invention is characterized in that the second layer comprises Cr, each pair of layers having a thickness between 1.6 and 2.0 nm. It was found that, if the thickness of each pair of layers of the coating is within said range, the coating has an optimum hardness which equals approximately four times the hardness of Cr.

A further embodiment of a cutting member according to the invention is characterized in that between the substrate and the pair of layers which is closest to the substrate, the coating comprises an implanted layer of Cr. The implanted layer of Cr strongly improves the adhesion of the coating to the substrate, so that the durability of the cutting member is further improved.

A yet further embodiment of a cutting member according to the invention is characterized in that between the implanted layer of Cr and the pair of layers which is closest to the substrate, the coating comprises a basic layer of CrN. The basic layer of CrN further improves the adhesion of the coating to the substrate. In addition, the basic layer absorbs residual stresses which remain in the stacked pairs of layers when the coating is provided on the substrate.

A particular embodiment of a cutting member according to the invention is characterized in that the coating has a thickness between 50 and 200 nm. It was found that, if the coating has an overall thickness between 50 and 200 nm, on the one hand the coating has a sufficient number of pairs of layers to achieve the properties of a superlattice coating, while on the other hand the thickness of the coating is sufficiently small to achieve a sufficient sharpness of the coated cutting edge and hence sufficiently low cutting forces.

A further embodiment of a cutting member according to the invention is characterized in that the coating has a thickness between 80 and 120 nm. It was found that, if the coating has an overall thickness between 80 and 120 nm, an optimum combination of properties of the superlattice coating and sharpness of the cutting edge is achieved.

Embodiments of a cutting member and a device for shaving hair in accordance with the invention are described in the following with reference to the drawings, in which

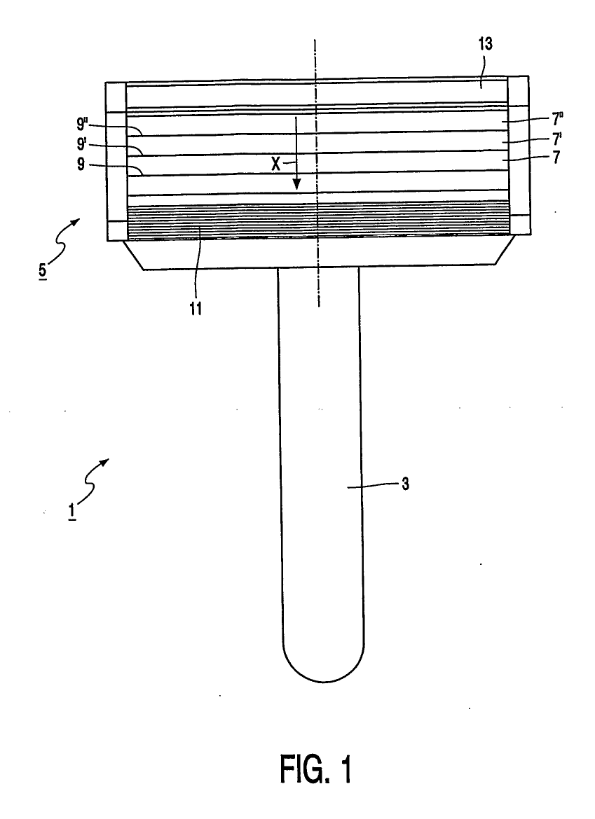

FIG. 1 shows a device for shaving hair in accordance with the invention,

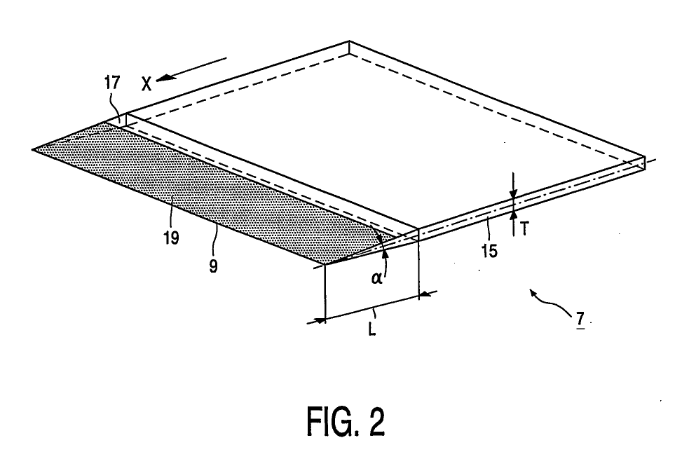

FIG. 2 shows a cutting member according to the invention used in the device of FIG. 1, and

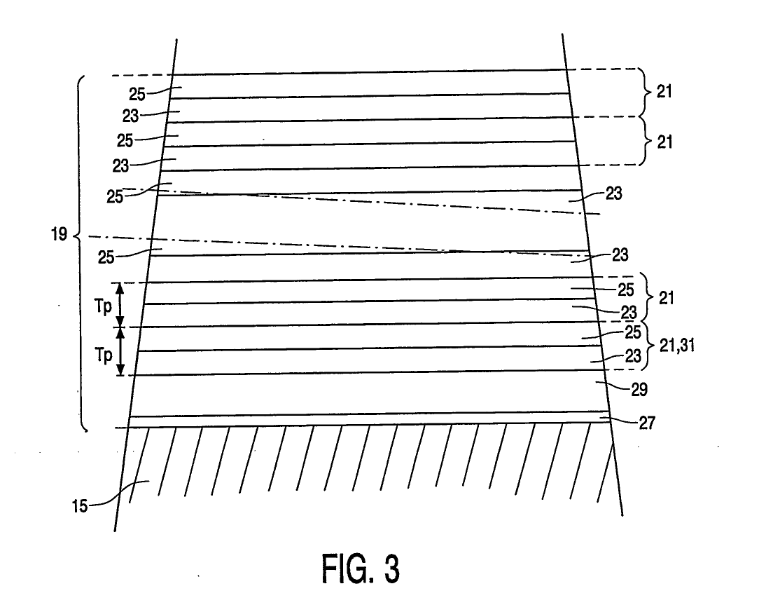

FIG. 3 schematically shows a cross-section of a protective coating of the cutting member of FIG. 2.

The device for shaving hair in accordance with the invention shown in FIG. 1 comprises a base portion 1 having a grip 3. The device further comprises a disposable shaving head 5 which is releasibly mounted to the base portion 1. The shaving head 5 comprises three metal cutting members 7, 7′, 7″ according to the invention which are each provided with a straight cutting edge 9, 9′, 9″. The cutting edges 9, 9′, 9″ are oriented parallel with respect to each other and define a cutting direction X in which the shaving head is to be moved over a skin with hairs to be shaved, said cutting direction X extending perpendicularly to the cutting edges 9, 9′, 9″. The shaving head 5 further comprises a first skin supporting member 11, which is profiled and positioned ahead of the cutting members 7, 7′, 7″ when the shaving head 5 is moved in the cutting direction X so as to have a skin stretching effect. A second skin-supporting member 13 is arranged in the shaving head 5 behind the cutting members 7, 7′, 7″.

FIG. 2 shows the cutting member 7 in detail. The cutting members 7′ and 7″ are identical to the cutting member 7. The cutting member 7 comprises a blade-shaped substrate 15 made of steel. The cutting edge 9 constitutes the tip of a wedge-shaped portion 17 of the substrate 15. In the embodiment shown the substrate has a maximal thickness T of approximately 0.1 mm, and the wedge-saped portion 17 has a main tip angle α of approximately 12°, so that a length L of the wedge-shaped portion 17 is approximately 0.5 mm. The tip of the wedge-shaped portion 17, which is not visible in detail in FIG. 2, is rounded and has an end radius which is smaller than approximately 40 nm so as to provide the cutting edge 9 with sufficient sharpness.

As shown in FIG. 2, a major portion of the wedge-shaped portion 17 is provided with a protective coating 19, said major portion including the cutting edge 9. As shown in FIG. 3, the coating 19 comprises a plurality of stacked pairs 21 of layers. Each pair 21 of layers comprises a first layer 23 mainly comprising carbon (C) and a second layer 25 mainly comprising chromium (Cr). In the embodiment shown, each pair 21 of layers has a thickness T_{P} of approximately 1.8 nm, the first layers 23 and the second layers 25 having approximately equal thicknesses, and the coating 19 has an overall thickness of approximately 100 nm. Thus the coating 19 has a nano-scale multi-layered structure, wherein each layer 23, 25 has a thickness equal to only a small number of times the diameter of a single atom. Within such a structure the atoms present in the adjacent layers 23, 25 of the coating 19 will be arranged in a so-called superlattice. A number of physical properties of such a superlattice are superior to the physical properties, which the materials of the layers 23, 25 have individually and which the coating 19 would have if the thickness of the individual layers 23, 25 as much larger. It was found that, if in accordance with the invention the first layer 23 of each pair 21 of layers mainly comprises carbon, the coating 19 provides a coefficient of friction between the cutting member 7 and the hair to be shaved which is considerably lower than the coefficient of friction which would be obtained without the coating 19. It was further found that in the embodiment shown in FIG. 3, wherein the second layer 25 of each pair 21 of layers mainly comprises Cr, the coating 19 has a hardness which is approximately four times the hardness of Cr and which, as a result, is superior to the average hardness which would be provided by a coating of diamond-like carbon. As a result, the device for shaving hair in accordance with the invention comprising the cutting member 7 in accordance with the invention provides shaving comfort which is at least comparable to the shaving comfort of a cutting member provided with a coating of diamond-like carbon, and has a resistance to wear and a life time which are superior to the resistance to wear and the life time provided by a coating of diamond-like carbon.

In the embodiment shown in FIG. 3, an implanted layer 27 of Cr is provided on the substrate 15. The implanted layer 27 of Cr strongly improves the adhesion of the coating 19 to the substrate 15, so that the durability of the cutting member 7 is further improved. Furthermore, in the embodiment shown in FIG. 3, a basic layer 29 of CrN is provided between the implanted layer 27 and the pair 31 of layers which is closest to the substrate 15. The basic layer 29 of CrN further improves the adhesion of the coating 19 to the substrate 15. In addition, the basic layer 29 absorbs residual stresses which remain in the stacked pairs 21 of layers when the coating 19 is provided on the substrate 15. In the embodiment shown in FIG. 3 the implanted layer 27 of Cr is provided in a first step in the process of providing the coating 19, wherein the substrate 15 is cleaned and implanted with Cr⁺ ions generated by a steered arc cathode discharge. The basic layer 29 of CrN is provided by means of a PVD process, which constitutes a second step in the process of providing the coating 19. Finally, the pairs 21 of layers of the coating 19 are provided by means of a vacuum PVD process, which constitutes a third step in the process of providing the coating 19. During said third process step the substrate 15 is placed in a vacuum chamber in which targets of carbon and chromium are arranged. During the PVD process the substrate 15 is rotated at a predetermined speed, so that the substrate 15 alternately faces the carbon target and the chromium target. The thickness of the first layers 23 and the second layers 25 is determined by the rotational speed of the substrate 15 and by the deposition rates of the targets.

It is noted that in accordance with the invention the pairs 21 of layers of the coating 19 may have a thickness T_{P} different from 1.8 nm as in the embodiment of FIG. 3. It was found that the hardness of the coating 19 is dependent on the thickness T_{P} of the pairs 21 of layers and that the hardness has a maximal value of approximately four times the hardness of Cr if the thickness T_{P} is between 1.6 and 2.0 nm. If the thickness T_{P} is outside this range, however, the coating 19 may still have a hardness which is superior to the hardness of Cr. Such a superior hardness is particularly achieved when the thickness T_{P} is such that the coating 19 has a superlattice structure. It was found that a superlattice coating of carbon and chromium layers is obtained if the thickness T_{P} is between 1 and 10 nm, so that the invention covers said range of values for the thickness T_{P}.

It is further noted that in accordance with the invention the coating 19 may have an overall thickness different from 100 nm as in the embodiment of FIG. 3. On the one hand, the overall thickness of the coating 19 must be such that the coating 19 has a sufficient number of pairs 21 of layers to obtain the properties of a superlattice coating. It was found that a minimal overall thickness of 50 nm is necessary to provide a sufficient number of pairs 21 of layers. On the other hand, the overall thickness of the coating 19 must be sufficiently small to obtain sufficient sharpness of the coated cutting edge 9 and hence to achieve sufficiently low cutting forces of the cutting member 7. It was found that acceptable values of the cutting force are obtained if the overall thickness of the coating 19 is below 200 nm. As a result, the invention covers embodiments of a cutting member 7 wherein the overall thickness of the superlattice coating 19 is between 50 and 200 nm. It was found, however, that an optimum combination of sharpness, cutting forces, and properties of the superlattice coating 19 is achieved if the overall thickness of the coating is between 80 and 120 nm.

It is further noted that the invention also covers embodiments in which the second layer 25 of each pair 21 of layers of the coating 19 mainly comprises a metal other than Cr. It was found that, as a result of the presence of a metal in the coating 19, in general the superlattice coating 19 has a hardness which is a multiple of the hardness which the metal has individually, and a skilled person will be able to find by means of experiments any suitable metal providing the coating 19 with a desired hardness superior to the hardness of known coatings used in razors or shavers. In particular it was found that such a superior hardness is achieved when the second layer 25 of each pair 21 of layers of the coating 19 comprises, instead of Cr, niobium (Nb), molybdenum (Mo), titanium (Ti), vanadium (V), or tungsten (W), but a skilled person will be able to find also other suitable metals. For each suitable metal a skilled person will also be able to find the optimum values for the thickness T_{P} of each pair of layers and for the overall thickness of the superlattice coating. It is also noted that the coating 19, comprising pairs of layers with Cr or another suitable metal, may have an implanted layer 27 of a material other than Cr or a basic layer 29 of a material other than CrN, and the skilled person will be able to find other suitable metals for the implanted layer 27 and other suitable materials for the basic layer 29.

In the embodiment of FIG. 1 the device for shaving hair in accordance with the invention comprises a disposable shaving head 5 in which three cutting members 7, 7′, 7″ according to the invention are arranged, said shaving head 5 being releasibly mounted to the base portion 1. It is noted that the invention also covers embodiments in which one or more cutting members are arranged in a shaving head which is not releasable from the base portion. The invention further covers embodiments in which the device for shaving hair comprises a different number of cutting members in accordance with the invention, for example one, two, or four cutting members. It is further noted that the expression “device for shaving hair” in the claims does not only cover a device of the kind shown in FIG. 1 comprising a base portion with a shaving head comprising cutting members mounted thereto, but also disposable or nondisposable shaving heads of a kind similar to the shaving head 5 in FIG. 1, which comprise at least one cutting member according to the invention and are suitable for being mounted to a base portion of a shaver or razor.

In the embodiment of FIG. 1 the cutting members 7, 7′, 7″ are mounted in a fixed or in a substantially fixed position in the shaving head 5. It is finally noted that the invention also covers embodiments of a device for shaving hair in which one or more than one cutting member in accordance with the invention can be driven with respect to a base portion of the device by means of a suitable driving mechanism provided in said device. The cutting member may, for example, make a reciprocating or vibrating motion with respect to the base portion during operation so as to provide, for example, a reduction of the cutting forces.

1. A cutting member for use in a device for shaving hair, said cutting member having a metal substrate which is provided with a cutting edge, at least a portion of the substrate including the cutting edge being provided with a coating comprising carbon, characterized in that the coating comprises a plurality of stacked pairs of layers, each pair comprising a first layer mainly comprising carbon and a second layer mainly comprising a metal, and each pair having a thickness between 1 and 10 nm.

2. A cutting member as claimed in claim 1, characterized in that the second layer comprises Cr, Nb, Mo, Ti, V, or W.

3. A cutting member as claimed in claim 1, characterized in that the second layer comprises Cr, each pair of layers having a thickness between 1.6 and 2.0 nm.

4. A cutting member as claimed in claim 3, characterized in that between the substrate and the pair of layers which is closest to the substrate, the coating comprises an implanted layer of Cr.

5. A cutting member as claimed in claim 4, characterized in that between the implanted layer of Cr and the pair of layers, which is closest to the substrate, the coating comprises a basic layer of CrN.

6. A cutting member as claimed in claim 1, characterized in that the coating has a thickness between 50 and 200 nm.

7. A cutting member as claimed in claim 6, characterized in that the coating has a thickness between 80 and 120 nm.

8. A device for shaving hair comprising a cutting member having a metal substrate which is provided with a cutting edge, at least a portion of the substrate including the cutting edge being provided with a coating comprising carbon, characterized in that the cutting member is a cutting member as claimed in claim 1.
